(19) United States
(12) Patent Application Publication
(10) Pub. No.: US 2023/0041363 A1
(43) Pub. Date: Feb. 9, 2023

(54) CONDUIT LAYOUT APPARATUS, METHOD OF MAKING AND USING THE SAME

(71) Applicant: James Montelongo, Denver, CO (US)

(72) Inventor: James Montelongo, Denver, CO (US)

(21) Appl. No.: 17/884,235

(22) Filed: Aug. 9, 2022

Related U.S. Application Data
(60) Provisional application No. 63/231,144, filed on Aug. 9, 2021.

(51) Int. Cl. H02G 3/04

(52) U.S. Cl. CPC H02G 3/0406

(57) ABSTRACT

A conduit layout tool to configured for forming conduit holes or knockouts in electrical boxes or panels. The conduit layout tool can be used with different size strut channel sizes have different widths, height, gauge size and material. The typical width channel sizes are 1⅝ inch and 13/16 inch with (or 7/16 width). A single conduit tool is configured to be used with two or more channel width sizes each with a single conduit diameter.

### CROSS REFERENCE TO RELATED APPLICATION

This application claims the benefit under 35 U.S.C. § 119(e) of U.S. Provisional Application No. 63/231,144, filed Aug. 9, 2021, which is fully incorporated herein by reference.

### BACKGROUND OF THE INVENTION

### Field of the Invention

The present invention generally relates to a conduit layout apparatus, method of making and using the same and more particularly to a conduit layout tool used for forming one or more knockouts in electrical panels, boxes and enclosures.

### SUMMARY OF THE INVENTION

Accordingly, the invention is directed to a conduit layout apparatus, method of making and using the same that substantially obviates one or more of the problems due to limitations and disadvantages of the related art.

An advantage of the invention is to provide a system that allows for rapid layout of one or more knockouts in an electrical panel.

Another advantage of the invention is to provide a conduit layout tools for use in various types of knockouts and size conduits.

Yet another advantage invention is allowing a user to not have to know the diameters of all of the trade size electrical conduits by memory, or by reference of a chart in order to determine the center point needed to knockout desired holes. For example, an embodiment of the invention eliminates the need for having to figure out how much space to allow between adjacent conduits of different or the same size in order to provide code required securing and supporting of the conduits. Moreover and embodiment of the invention also solves the problem of inconsistent spacing between conduits due to the inventions' pre-determined sizing, which when properly placed as designed will deliver consistent spacing. The invention will also save time to layout multiple center knockout points at one time compared to the traditional methods of layout and tools currently used which typically only allow for one conduit at a time.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

To achieve these and other advantages and in accordance with the purpose of the present invention, as embodied and broadly described, a template for arranging electrical conduit drill hole positions on an electrical panel housing, The template a first end, a second end spaced apart from the first end by a length, a first side and a second side spaced apart from the first side by a width. The width is less than the length. The first end includes a first end notch arranged between the first side and the second side configured to indicate a central axis or midline of the template. The second end comprises a second end notch arranged between the first side and the second side configured to indicate the central axis or midline of the template. The template also includes a first and second pilot hole. The first pilot hole is configured to be used to form an electrical conduit drill hole and arranged between the first end and the second end on the central axis of the template, wherein the first pilot hole is arranged at a location for use with a 1⅝ inch strut channel. The second pilot drill hole is configured to be used to form an electrical conduit drill hole arranged between the first end and the second end on the central axis of the template, wherein the first pilot hole is arranged at a location for use with a 13/16 or ⅞ inch strut channel.

In another aspect of the present invention, a method for laying out the locations of electrical conduit entry holes to be made on an electrical panel housing including providing according to any of the embodiments described herein. The method also includes arranging the template on the electrical panel in a preconfigured orientation and marking the electrical panel with one of the first pilot drill hole or second pilot drill hole. The method further includes forming a knockout with the first pilot drill hole or the second pilot drill hole. Finally, this method can be repeated as necessary.

In embodiments herein the term template and conduit layout are used interchangeably.

This Summary section is neither intended to be, nor should be, construed as being representative of the full extent and scope of the present disclosure. Additional benefits, features and embodiments of the present disclosure are set forth in the attached figures and in the description hereinbelow, and as described by the claims. Accordingly, it should be understood that this Summary section may not contain all of the aspects and embodiments claimed herein.

Additionally, the disclosure herein is not meant to be limiting or restrictive in any manner. Moreover, the present disclosure is intended to provide an understanding to those of ordinary skill in the art of one or more representative embodiments supporting the claims. Thus, it is important that the claims be regarded as having a scope including constructions of various features of the present disclosure insofar as they do not depart from the scope of the methods and apparatuses consistent with the present disclosure (including the originally filed claims). Moreover, the present disclosure is intended to encompass and include obvious improvements and modifications of the present disclosure.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 illustrates an exemplary view of a V2 inch electrical conduit layout apparatus for use with a 1⅝ inch and 13/16 inch (or ⅞ inch) strut channel according to an embodiment of the invention.

FIG. 2 illustrates an exemplary view of a ¾ inch electrical conduit layout apparatus for use with a 1⅝ inch and 13/16 inch (or ⅞ inch) strut channel according to another embodiment of the invention.

FIG. 3 illustrates an exemplary view of a 1 inch conduit layout apparatus for use with a 1⅝ inch and 13/16 inch (or ⅞ inch) strut channel according to another embodiment of the invention.

FIG. 4 illustrates an exemplary view of a 1¼ inch conduit layout apparatus for use with a 1⅝ inch and 13/16 inch (or ⅞ inch) strut channel according to another embodiment of the invention.

FIG. 5 illustrates an exemplary view of a 1½ inch conduit layout apparatus for use with a 1⅝ inch and 13/16 inch (or ⅞ inch) strut channel according to another embodiment of the invention.

FIG. 6 illustrates an exemplary view of a 2 inch conduit layout apparatus for use with a 1⅝ inch and 13/16 inch (or ⅞ inch) strut channel according to another embodiment of the invention.

FIG. 7 illustrates an exemplary view of a 2½ inch conduit layout apparatus for use with a 1⅝ inch and 13/16 inch (or ⅞ inch) strut channel according to another embodiment of the invention.

FIG. 8 illustrates an exemplary view of a 3 inch conduit layout apparatus for use with a 1⅝ inch and 13/16 inch (or ⅞ inch) strut channel according to another embodiment of the invention.

FIG. 9 illustrates an exemplary view of a 4 inch conduit layout apparatus for use with a 1⅝ inch and 13/16 inch (or ⅞ inch) strut channel according to another embodiment of the invention.

FIG. 10 illustrates an exemplary view of a ¾ inch conduit layout apparatus, 1¼ inch conduit layout apparatus and 1 inch conduit layout apparatus arranged side by side on a panel for use with a 1⅝ inch and 13/16 inch (or ⅞ inch) strut channel according to another embodiment of the invention.

FIG. 11 illustrates an exemplary view of a ¾ inch conduit layout apparatus, ¾ inch conduit layout apparatus, ½ inch conduit layout apparatus and 1¼ inch conduit layout apparatus arranged side by side on a panel for use with a 1⅝ inch and 13/16 inch (or ⅞ inch) strut channel according to an embodiment of the invention.

FIG. 12 illustrates an exemplary view of ten ¾ inch conduit layout apparatuses arranged side by side on a panel for use with a 1⅝ inch strut channel according to an embodiment of the invention.

FIG. 13 illustrates an exemplary flowchart view of method of using the conduit layout apparatus.

### DETAILED DESCRIPTION OF THE ILLUSTRATED EMBODIMENTS

For the purposes of promoting an understanding of the principles of the present disclosure, reference will now be made to the exemplary embodiments illustrated in the drawing(s), and specific language will be used to describe the same.

Appearances of the phrases an “embodiment,” an “example,” or similar language in this specification may, but do not necessarily, refer to the same embodiment, to different embodiments, or to one or more of the figures. The features, functions, and the like described herein are considered to be able to be combined in whole or in part one with another as the claims and/or art may direct, either directly or indirectly, implicitly or explicitly.

As used herein, “comprising,” “including,” “containing,” “is,” “are,” “characterized by,” and grammatical equivalents thereof are inclusive or open-ended terms that do not exclude additional unrecited elements or method steps unless explicitly stated otherwise.

In order to more fully appreciate the present disclosure and to provide additional related features, the following references are incorporated therein by reference in their entirety:

(1) U.S. Pat. No. 1,540,991 issued to F. A. Homgren directed towards a gauge for making window frames and sashes upon which are to be secured storm or screen hangers.

(2) U.S. Pat. No. 1,545,424 issued to J. L. Heimrich which is directed towards a template tool having adjustable section.

(3) U.S. Pat. No. 3,664,026 issued to Lawson, which is directed towards a paper or fabric pattern strip adapted for use in making the pleated upper section of a drapery panel. Two such pattern strips may be used for forming the pleated section of a pair of drapes for a single window—each pattern strip being adapted for use in forming the opposite side hems and return or border areas and in uniformly spacing the pleated areas of a drapery. By use of the pattern strip of the invention, several widths of fabric may be hemmed and pleated to a certain width with the pleated drapery of each fabric width having uniform pleat spacings and spacings equal to the pleat spacings of each other fabric width. The pattern strip means preferably is in two embodiments adapted for use respectively in forming an odd number of pleats or an even number of pleats in the pleated upper section of a drapery panel.

(4) U.S. Pat. No. 4,538,354 issued to Smolik which is directed towards a magnetically adhering template having a flat, rigid base and a flexible magnetized pad fixed to and substantially coextensive with the base. Template openings of desired shape and location are provided in the base. Corresponding openings are provided in the magnetized pad and are desirably slightly larger than those in the base so that portions of the pad adjacent the pad openings do not interfere with the use of the template openings of the base. The template is useable on a surface of magnetically attractive material, such as a steel wall stud.

(5) U.S. Pat. No. 4,998,355 issued to Greene which is directed towards a marking device for accurately positioning two opposing marks on two opposing surfaces, for use in aligning two members in accurate registration with one another. The device is formed of a flexible, foldable, flat sheet, which is folded in half at its midportion. The two halves contain matching patterns of holes such that when the sheet is in its folded configuration the holes at each pattern lie in registration with one another. The two halves of the sheet are marked with corresponding indicia, which label corresponding holes of the two patterns. The opposing end portions of the two halves are each adapted to be removably secured to the structure being marked. Two opposed alignment marks are made by securing a first half of the strip against a first surface and making a mark through one of the holes. With the second half of the strip in registration with the first half, the second half is secured to the second surface. The first half is then removed from the first surface and a mark is made on the second surface through the hole in the second pattern corresponding to the first hole.

(6) U.S. Pat. No. 5,107,601 issued to Semchuck, which is directed towards a mounting template 10 is formed from a flexible strip 12 of paper material and has indicia printed or formed on a first face 14 thereof. The indicia defines hole patterns A, B, C and D each of which include circles 18 representing hole locations. A rear or second face 16 of the strip 12 has applied thereto a low-tack pressure-sensitive backing 28 of adhesive material which is covered by a removable cover 30. The mounting template 10 can be adhesively mounted on a wall surface and the indicia provides precise and accurate locations of holes to be formed in the surface. The holes facilitate attachment of brackets to the surface which support, for example, bathroom fixtures or accessories.

(7) U.S. Pat. No. 5,655,330 issued to Parsons, III, which is directed towards a slab pattern tool for termite treatment drilling in which the tool comprises a drill pattern (11) with a series of color coordinated drilling holes (12) wherein the colors represent different spacing patterns, and a set of adjustment footings (14) which abut the wall of the building being treated and allow for adjustment away from the foundation footing at the wall.

(8) U.S. Pat. No. 6,077,000 issued to Gibbons, et al., which is directed towards a template with which pipework may be correctly positioned in a wall for connection to a wall mounted unit, the template comprising first apertures for guiding drills at desired positions of pipes in the wall, and second apertures for screwing the template to a wall, wherein the second apertures are spaced and dimensioned such that the wall mounted unit may be mounted on the wall using the screw holes created by the second apertures and be correctly aligned with pipework positioned according to the first apertures, each of the first apertures may comprise a centrally mounted annular member defining an aperture through which a center hole may be drilled.

(9) U.S. Patent Appl. Publication No. 2004/0003507 issued to Jordan, et al., which is directed towards an electrician's conduit layout tool to facilitate placing conduit holes in electrical boxes wherein a small rectangular tool is provided having marking point for both sizes of strut, all parallel conduit marking locations in its peripheral edge and center marking locations for all conduit sizes on a one piece durable Tool. A three step method is used to layout any combination of conduits with no calculations. Is also used in strut rack layout parallel conduit marking locations in its peripheral edge. A panel schedule is also etched into the conduit layout tool for a wire-pulling guide. Lines are drawn through the center of the circumferential trace to facilitate the positioning of a conventional knockout.

(10) U.S. Patent Appl. Publication No. 2004/0103550 issued to Grendahl, a template provides a quick and accurate method for marking locations of conduit entry holes to be formed in an electrical panelboard. The template is a rectangular sheet that is divided into longitudinal spacer zones, transverse spacer zones, a longitudinal marking zone and graduated marking zones. Each of the marking zones has multiple apertures used in making marks on the electrical panelboard to identify hole locations.

(11) U.S. Design Pat. No. D757,576 by Jordan et al. which discloses an ornamental design for a conduit layout tool.

(12) U.S. Design Pat. No. D835,534 by Jordan et al. which discloses an ornamental design for a conduit layout tool.

One embodiment is directed towards a conduit layout tool configured for forming conduit holes or knockouts in electrical boxes or panels, e.g., industrial boxes or panels. The conduit layout tool can be used with different size strut channel sizes have different widths, height, gauge size and material. The typical width of channel sizes are 1⅝ inch and 13/16 inch with (or 7/16 width). A single conduit tool is configured to be used with two or more channel width sizes each with a single conduit diameter. The conduit diameter is a range from about ½ inch to 4 inch or greater.

In one embodiment, the conduit layout tool is configured to allow a user quick and accurate method for marking pre-drill hole locations for at least two or more sized channels in a single template with a single conduit size diameter.

In one embodiment, the template or conduit layout tool includes a first end, a second end spaced apart from the first end by a length, a first side and a second side spaced apart from the first side by a width. The first end includes a first end notch arranged between the first side and the second side configured to indicate a central axis or midline of the template. The second end includes a second end notch arranged between the first side and the second side configured to indicate the central axis or midline of the template.

The template or conduit layout tool further includes a first pilot drill hole arranged between the first end and the second end on the central axis of the template. The first pilot hole is configured to permit forming an electrical conduit drill hole or knockout with a channel width of 1⅝ inches. The second pilot hole is configured to permit forming an electrical conduit drill hole of about 0.5 inch such that the outer diameter of the drill hole is about ⅞ inches from the second end.

The template or conduit layout tool also includes a second pilot drill hole arranged between the first end and the second end on the central axis of the template. The first pilot hole is configured to permit forming an electrical conduit drill hole or knockout with a channel width of 13/16 inches or ⅞ inches. The second pilot hole is configured to permit forming an electrical conduit drill hole of about 0.5 inch such that the outer diameter of the drill hole is about ⅞ inches from the second end.

In one embodiment, separate templates are utilized for each sized conduit, e.g., a template for a ½ inch conduit, ¾ inch conduit, 1 inch conduit, 1¼ inch conduit, 1½ in conduit, 2 inch conduit, 2½ inch conduit, 3 inch conduit, and 4 inch conduit. In addition, any size conduit in a range from about ¼ inch to 4 inches or greater can be utilized with the template. In one embodiment, the template can include more than one template, e.g., a ½ conduit template and 1 inch conduit template or the same size conduit templates side by side.

The template may be formed from any material including but not limited to a metal material, an aluminum material, an alloy material, a steel material, a galvanized steel material, a thermoplastic material, a plastic material, a polymer material, a paper material, a cardboard material, a magnetic material, and combinations of the same.

Optionally and/or alternatively, the template may include a magnetic material adhered to at least a portion of the template. The magnetic material is configured to allow the template to become releasably attached to the panel.

In one embodiment, the template may be a transparent material or any color material, e.g., any combination of red, green, and blue, e.g., black, orange, red, blue, and the like.

In one embodiment, the template may include on more templates in a kit or package for an end-user.

In one embodiment, there may be custom groupings of templates into a larger template in a kit or package for the user. That is any template in any figure or description may be combined to a larger template. The custom groupings can include one or more templates, e.g., two templates, three templates, four templates, five templates or more templates.

In one embodiment, the template may be created as a sticker, decal or other type of material configured to be releasably or permanently attached to a panel. Optionally, the template could be configured as a stencil that allows a user to paint the template on the panel, e.g., spray paint.

In one embodiment, the template may only include one size conduit instead of two sizes of conduit, e.g., ⅞ inch or 1⅝ inch template.

In one embodiment, the templates may include additional graphics, pictures, logos, and the like. For example, in one embodiment, the graphic or picture is configured to mimic a conduit holder, axis lines including vertical axis lines, diagonal axis lines and/or horizontal axis lines.

In one embodiment, the notches are added to the template at or near the knockout as guide for conduit or other secondary devices or cut out tools as shown in one or more figures or other orientation of the template.

In one embodiment, the template has a width in a range from about 1 inch to about 4 inches or greater. In one embodiment, the template has a height in a range from about 2 inches to about 8 inches or greater, and in a preferred embodiment in a range from about 6 inches to about 8 inches. In one embodiment, the template has a thickness in a range from about 1/16 inch to about ⅛ inch or greater or smaller.

Reference will now be made in detail to an embodiment of the present invention, example of which is illustrated in the accompanying drawings.

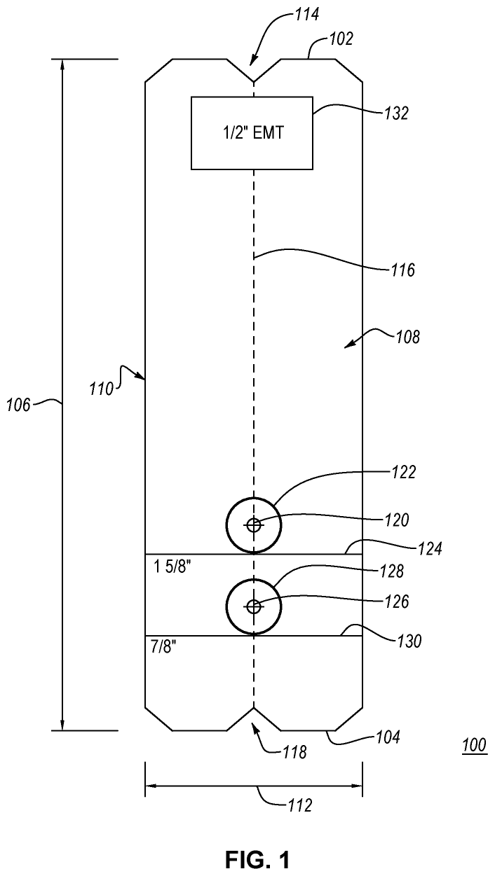

FIG. 1 illustrates an exemplary view of a ½ conduit layout apparatus for use with a 1⅝ inch and ⅞ inch strut channel according to an embodiment of the invention.

Referring to FIG. 1, the ½ inch conduit apparatus is generally depicted with reference number 100. The template 100 is configured for a ½ inch conduit, e.g., electric metallic tube (EMT) conduit, rigid conduit, electrical nonmetallic tubing (ENT), flexible metal conduit (FMC), intermediate metal conduit (IMC), liquid tight flexible nonmetallic conduit (FNC-B), rigid PVC conduit schedule 80 and schedule 40, high-density polyethylene (HDPE) conduit, Type A rigid PVC conduit, type EB, PVC conduit and the like. The template 100 includes a first end 102, a second end 104 spaced apart from the first end by a length 106, a first side 108 and a second side 110 spaced apart from the first side 108 by a width 112, wherein the width 112 is less than the length 106.

The first end 102 includes a first end notch 114 arranged between the first side 108 and the second side 110 configured to indicate a central axis or midline 116 of the template 100. The second end 104 includes a second end notch 118 arranged between the first side 108 and the second side 110 configured to indicate the central axis or midline 116 of the template 100.

The template 100 includes a first pilot drill hole 120 arranged between the first end 102 and the second end 104 on the central axis 116 of the template. In this embodiment, the first pilot drill hole 120 is configured to permit forming an electrical conduit drill hole, knock-out, or knockout hole 122 having a diameter of about 0.5 inch. The first pilot drill hole 120 extends through the entire thickness of the template 100 from the first side 108 to the second surface 110.

The knockout 122 is formed by an end-user using a pilot hole 120 and a hole saw as known in the art. On bigger conduit sizes the pilot hole 120 is used with a hole saw followed by using a knockout tool as known in the art. In any of the conduit sizes the pilot hole 120 is utilized to prevent any measuring and allow for rapid use by the end-user.

In this embodiment, the line 124 is parallel to the second end 104 and tangential to an outside diameter of the knockout 122. The line 124 is configured to mimic or represent the outside portion or depth of a mounting strut, channel strut, e.g., Unistrut® channel. The strut (not shown) is mounted to a wall, ceiling, floor, or substrate and configured to allow securing and support of conduits with straps (not shown) to the strut. Typically, strut sizes vary in widths of the strut are 1⅝ inches, or 13/16 inches (or ⅞ inch strut). In this embodiment, the line 124 is configured to represent a 1⅝ inch strut.

The template 100 also includes a second pilot drill hole 126 arranged between the first end 102 and the second end 104 on the central axis 116 of the template. The second pilot drill hole 126 extends through the entire thickness of the template 100 from the first side 108 to the second surface 110. In this embodiment, the second pilot drill hole 126 is configured to permit forming an electrical conduit drill hole, knockout, or knockout hole 128 having a diameter of about 0.5 inch.

The knockout 128 is formed by an end-user using a pilot hole 126 and a hole saw, or hole cutter as known in the art. On bigger conduit sizes the pilot hole 126 is used with a hole saw followed by using a knockout tool as known in the art. In any of the conduit sizes the pilot hole 128 is utilized to prevent any measuring and rapid.

In this embodiment, the line 130 is parallel to the second end 104 and tangential to an outside diameter of the knockout 128. The line 130 is configured to mimic or represent the outside portion or depth of a 13/16 inch (or ⅞ inch) mounting strut, channel strut, e.g., Unistrut® channel. The 13/16 inch (or ⅞ inch) strut (not shown) is mounted to a wall, ceiling, floor, or substrate and configured to allow securing and support of conduits with straps (not shown) to the strut.

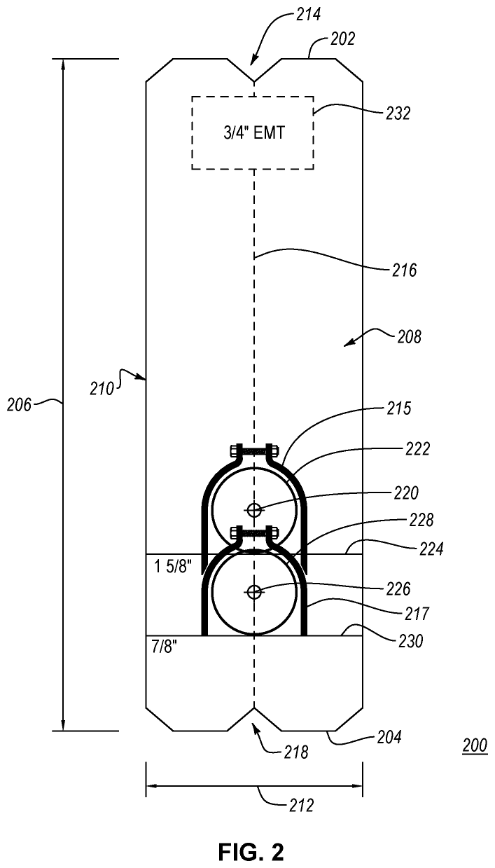

Optionally and/or alternatively, the template 100 also includes graphic region 132 and in this embodiment depicts a size of the conduit that the template can be used with, e.g., ½ inch EMT conduit. The center line 116 can be solid or dashed. Optionally and/or alternatively, the template 100 has a substantially rectangular shape with cut corner, beveled corners and corners having a right angle. In this embodiment, the template includes a plastic semi-rigid material with a magnetic material adhered to reverse side. The magnetic material is configured to allow the template to be releasably attached to a panel. Optionally and/or alternatively, the template 100 can include a graphic (see FIG. 2) that resembles an attachment strap used to attach the conduit to the strut.

FIG. 2 illustrates an exemplary view of a ¾ inch electrical conduit layout apparatus for use with a 1⅝ inch and 13/16 inch (or ⅞ inch) strut channel according to an embodiment of the invention.

Referring to FIG. 2, the ¾ inch conduit apparatus is generally depicted with reference number 200. The template 200 is configured for a ¾ inch conduit, e.g., electric metallic tube (EMT) conduit, rigid conduit, and other electrical conducts as described herein or known in the art. The template 200 includes a first end 202, a second end 204 spaced apart from the first end by a length 206, a first side 208 and a second side 210 spaced apart from the first side 208 by a width 212, wherein the width 212 is less than the length 206.

The first end 202 includes a first end notch 214 arranged between the first side 208 and the second side 210 configured to indicate a central axis or midline 216 of the template 200. The second end 204 includes a second end notch 218 arranged between the first side 208 and the second side 210 configured to indicate the central axis or midline 216 of the template 200.

The template 200 includes a first pilot drill hole 220 arranged between the first end 202 and the second end 204 on the central axis 216 of the template. In this embodiment, the first pilot drill hole 220 is configured to permit forming an electrical conduit drill hole, knock-out, or knockout hole 222 having a diameter of about ¾ inch.

The knockout 222 is formed by an end-user using a pilot hole 220 and a hole saw as known in the art. On bigger conduit sizes the pilot hole 220 is used with a hole saw followed by using a knockout tool as known in the art. In any of the conduit sizes the pilot hole 220 is utilized to prevent any measuring and rapid. The first pilot drill hole 220 extends through the entire thickness of the template 200 from the first side 208 to the second surface 210.

In this embodiment, the line 224 is parallel to the second end 104 and tangential to an outside diameter of the knockout 222. The line 224 is configured to mimic or represent the outside portion or depth of a mounting strut, channel strut, e.g., Unistrut® channel The strut (not shown) is mounted to a wall, ceiling, floor, or substrate and configured to allow securing and support of conduits with straps (not shown) to the strut. Typically, strut sizes vary in widths of the strut are 1⅝ inches, or 13/16 inches (or ⅞ inch strut). In this embodiment, the line 224 is configured to represent a 1⅝ inch strut.

The template 200 also includes a second pilot drill hole 226 arranged between the first end 202 and the second end 204 on the central axis 216 of the template. In this embodiment, the second pilot drill hole 226 is configured to permit forming an electrical conduit drill hole, knockout, or knockout hole 228 having a diameter of about ¾ inch. The second pilot drill hole 226 extends through the entire thickness of the template 200 from the first side 208 to the second surface 210.

The knockout 228 is formed by an end-user using a pilot hole 226 and a hole saw, or hole cutter as known in the art. On bigger conduit sizes the pilot hole 226 is used with a hole saw followed by using a knockout tool as known in the art. In any of the conduit sizes the pilot hole 228 is utilized to prevent any measuring and allowing for rapid use.

In this embodiment, the line 230 is parallel to the second end 104 and tangential to an outside diameter of the knockout 228. The line 230 is configured to mimic or represent the outside portion or depth of a 13/16 inch (or ⅞ inch) mounting strut, channel strut, e.g., Unistrut®. The 13/16 inch (or ⅞ inch) strut (not shown) is mounted to a wall, ceiling, floor, or substrate and configured to allow securing and support of conduits with straps (not shown) to the strut.

Optionally and/or alternatively, the template 200 also includes graphic region 232 to include a size of the conduit the template can be used with, e.g., ¾ inch EMT conduit. The center line 216 can be solid or dashed. Optionally and/or alternatively, the template 200 has a substantially rectangular shape with cut corner, beveled corners and corners having a right angle. In this embodiment, the template includes a plastic semi-rigid material with a magnetic material adhered to reverse side. Optionally and/or alternatively, the template 200 also includes a graphic 215 and 217 that resembles an attachment strap used to attach the conduit to the strut to further visually aid the end-user. The magnetic material is configured to allow the template to be releasably attached to a panel.

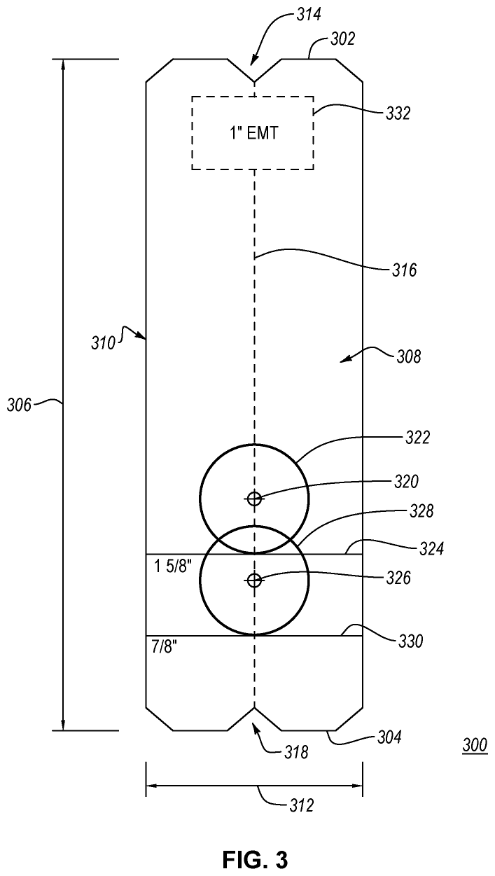

FIG. 3 illustrates an exemplary view of a 1 inch electrical conduit layout apparatus for use with a 1⅝ inch and 13/16 inch (or ⅞ inch) strut channel according to an embodiment of the invention.

Referring to FIG. 3, the 1 inch conduit apparatus is generally depicted with reference number 300. The template 300 is configured for a 1 inch conduit, e.g., electric metallic tube (EMT) conduit, Rigid conduit, and other electrical conducts as described herein and the like. The template 300 includes a first end 302, a second end 304 spaced apart from the first end by a length 306, a first side 308 and a second side 310 spaced apart from the first side 308 by a width 312, wherein the width 312 is less than the length 306.

The first end 302 includes a first end notch 314 arranged between the first side 308 and the second side 310 configured to indicate a central axis or midline 316 of the template 300. The second end 304 includes a second end notch 318 arranged between the first side 308 and the second side 310 configured to indicate the central axis or midline 316 of the template 300.

The template 300 includes a first pilot drill hole 320 arranged between the first end 302 and the second end 304 on the central axis 316 of the template. In this embodiment, the first pilot drill hole 320 is used by an end-user and configured to permit forming an electrical conduit drill hole, knock-out, or knockout hole 322 having a diameter of about 1 inch. The first pilot drill hole 320 extends through the entire thickness of the template 300 from the first side 308 to the second side 310.

The knockout 322 is formed by using a pilot hole 320 and a hole saw as known in the art. On bigger conduit sizes the pilot hole 320 is used with a hole saw followed by using a knockout tool as known in the art. In any of the conduit sizes the pilot hole 320 is utilized to prevent any measuring and rapid.

In this embodiment, the line 324 is parallel to the second end 304 and tangential to an outside diameter of the knockout 322. The line 324 is configured to mimic or represent the outside portion or depth of a mounting strut, channel strut, e.g., Unistrut®. The strut (not shown) is mounted to a wall, ceiling, floor, or substrate and configured to allow securing and support of conduits with straps (not shown) to the strut. Typically, strut sizes vary in widths of the strut are 1⅝ inches, or 13/16 inches (or ⅞ inch strut). In this embodiment, the line 324 is configured to represent a 1⅝ inch strut.

The template 300 also includes a second pilot drill hole 326 arranged between the first end 302 and the second end 304 on the central axis 316 of the template. In this embodiment, the second pilot drill hole 326 is configured to permit forming an electrical conduit drill hole, knockout, or knockout hole 328 having a diameter of about 1 inch. The second pilot drill hole 326 extends through the entire thickness of the template 300.

The knockout 328 is formed using a pilot hole 326 and a hole saw, or hole cutter as known in the art. On bigger conduit sizes the pilot hole 326 is used with a hole saw followed by using a knockout tool as known in the art. In any of the conduit sizes the pilot hole 328 is utilized to prevent any measuring and rapid.

In this embodiment, the line 330 is parallel to the second end 304 and tangential to an outside diameter of the knockout 328. The line 330 is configured to mimic or represent the outside portion or depth of a 13/16 inch (or ⅞ inch) mounting strut, channel strut, e.g., Unistrut®. The 13/16 inch (or ⅞ inch) strut (not shown) is mounted to a wall, ceiling, floor, or substrate and configured to allow securing and support of conduits with straps (not shown) to the strut.

Optionally and/or alternatively, the template 300 also includes graphic region 332 to include a size of the conduit the template can be used with, e.g., 1 inch EMT conduit. The center line 316 can be solid or dashed. Optionally and/or alternatively, the template 300 has a substantially rectangular shape with cut corner, beveled corners and corners having a right angle. In this embodiment, the template includes a plastic semi-rigid material with a magnetic material adhered to reverse side. The magnetic material is configured to allow the template to be releasably attached to a panel. Optionally and/or alternatively, the template 300 can include a graphic (see FIG. 2) that resembles an attachment strap used to attach the conduit to the strut.

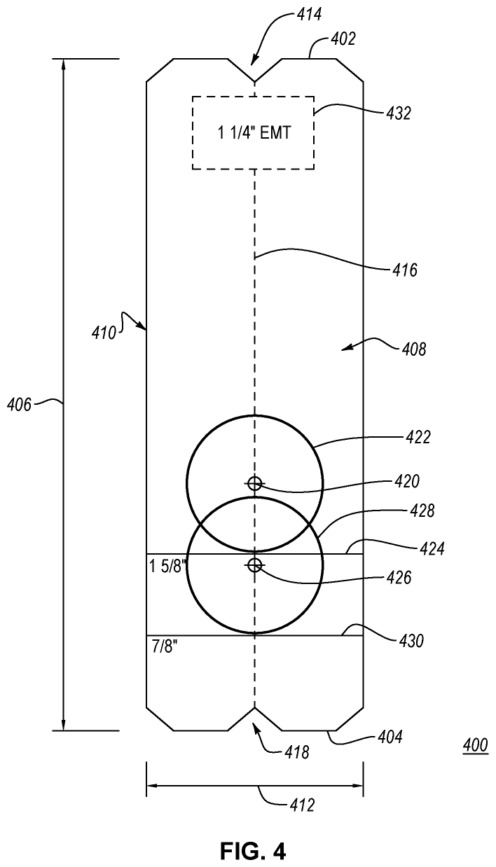

FIG. 4 illustrates an exemplary view of a 1¼ inch electrical conduit layout apparatus for use with a 1⅝ inch and 13/16 inch (or ⅞ inch) strut channel according to an embodiment of the invention.

Referring to FIG. 4, the 1¼ inch conduit apparatus is generally depicted with reference number 400. The template 400 is configured for a 1¼ inch conduit, e.g., electric metallic tube (EMT) conduit, Rigid conduit, and other electrical conducts. The template 400 includes a first end 402, a second end 404 spaced apart from the first end by a length 406, a first side 408 and a second side 410 spaced apart from the first side 408 by a width 412, wherein the width 412 is less than the length 406.

The first end 402 includes a first end notch 414 arranged between the first side 408 and the second side 410 configured to indicate a central axis or midline 416 of the template 400. The second end 404 includes a second end notch 418 arranged between the first side 408 and the second side 410 configured to indicate the central axis or midline 416 of the template 400.

The template 400 includes a first pilot drill hole 420 arranged between the first end 402 and the second end 404 on the central axis 416 of the template. In this embodiment, the first pilot drill hole 420 is configured to permit forming an electrical conduit drill hole, knock-out, or knockout hole 422 having a diameter of about 1¼ inch. The first pilot drill hole 420 extends through the entire thickness of the template 400.

The knockout 422 is formed using a pilot hole 420 and a hole saw as known in the art. On bigger conduit sizes the pilot hole 420 is used with a hole saw followed by using a knockout tool as known in the art. In any of the conduit sizes the pilot hole 420 is utilized to prevent any measuring and rapid.

In this embodiment, the line 424 is parallel to the second end 404 and tangential to an outside diameter of the knockout 422. The line 424 is configured to mimic or represent the outside portion or depth of a mounting strut, channel strut, e.g., Unistrut®. The strut (not shown) is mounted to a wall, ceiling, floor, or substrate and configured to allow securing and support of conduits with straps (not shown) to the strut. Typically, strut sizes vary in widths of the strut are 1⅝ inches, or 13/16 inches (or ⅞ inch strut). In this embodiment, the line 424 is configured to represent a 1⅝ inch strut.

The template 400 also includes a second pilot drill hole 426 arranged between the first end 402 and the second end 404 on the central axis 416 of the template. In this embodiment, the second pilot drill hole 426 is configured to permit forming an electrical conduit drill hole, knockout, or knockout hole 428 having a diameter of about 1¼ inch. The second pilot drill hole 426 extends through the entire thickness of the template 400.

The knockout 428 is formed using a pilot hole 426 and a hole saw, or hole cutter as known in the art. On bigger conduit sizes the pilot hole 426 is used with a hole saw followed by using a knockout tool as known in the art. In any of the conduit sizes the pilot hole 428 is utilized to prevent any measuring and rapid.

In this embodiment, the line 430 is parallel to the second end 404 and tangential to an outside diameter of the knockout 428. The line 430 is configured to mimic or represent the outside portion or depth of a 13/16 inch (or ⅞ inch) mounting strut, channel strut, e.g., Unistrut®. The 13/16 inch (or ⅞ inch) strut (not shown) is mounted to a wall, ceiling, floor, or substrate and configured to allow securing and support of conduits with straps (not shown) to the strut.

Optionally and/or alternatively, the template 400 also includes graphic region 432 to include a size of the conduit the template can be used with, e.g., 1¼ inch EMT conduit. The center line 416 can be solid or dashed. Optionally and/or alternatively, the template 400 has a substantially rectangular shape with cut corner, beveled corners and corners having a right angle. In this embodiment, the template includes a plastic semi-rigid material with a magnetic material adhered to reverse side. The magnetic material is configured to allow the template to be releasably attached to a panel. Optionally and/or alternatively, the template 400 can include a graphic (see FIG. 2) that resembles an attachment strap used to attach the conduit to the strut.

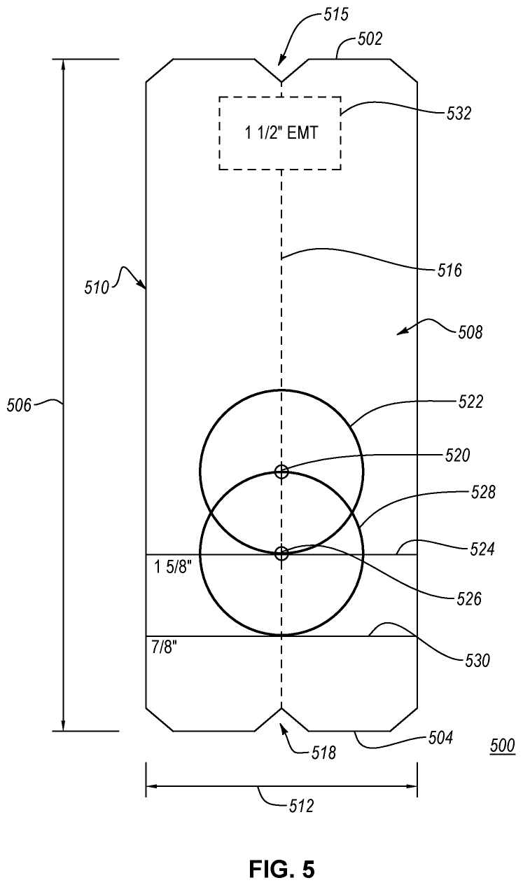

FIG. 5 illustrates an exemplary view of a 1¼ inch electrical conduit layout apparatus for use with a 1⅝ inch and 13/16 inch (or ⅞ inch) strut channel according to an embodiment of the invention.

Referring to FIG. 5, the 1½ inch conduit apparatus is generally depicted with reference number 500. The template 500 is configured for a 1½ inch conduit, e.g., electric metallic tube (EMT) conduit, Rigid conduit, and other electrical conducts. The template 500 includes a first end 502, a second end 504 spaced apart from the first end by a length 506, a first side 508 and a second side 510 spaced apart from the first side 508 by a width 512, wherein the width 512 is less than the length 506.

The first end 502 includes a first end notch 514 arranged between the first side 508 and the second side 510 configured to indicate a central axis or midline 516 of the template 500. The second end 504 includes a second end notch 518 arranged between the first side 508 and the second side 510 configured to indicate the central axis or midline 516 of the template 500.

The template 500 includes a first pilot drill hole 520 arranged between the first end 502 and the second end 504 on the central axis 516 of the template. In this embodiment, the first pilot drill hole 520 is configured to permit forming an electrical conduit drill hole, knock-out, or knockout hole 522 having a diameter of about 1½ inch.

The knockout 522 is formed using a pilot hole 520 and a hole saw as known in the art. On bigger conduit sizes the pilot hole 520 is used with a hole saw followed by using a knockout tool as known in the art. In any of the conduit sizes the pilot hole 520 is utilized to prevent any measuring and rapid. The pilot hole 520 extends through the entire thickness of the template 500.

In this embodiment, the line 524 is parallel to the second end 504 and tangential to an outside diameter of the knockout 522. The line 524 is configured to mimic or represent the outside portion or depth of a mounting strut, channel strut, e.g., Unistrut®. The strut (not shown) is mounted to a wall, ceiling, floor, or substrate and configured to allow securing and support of conduits with straps (not shown) to the strut. Typically, strut sizes vary in widths of the strut are 1⅝ inches, or 13/16 inches (or ⅞ inch strut). In this embodiment, the line 524 is configured to represent a 1⅝ inch strut.

The template 500 also includes a second pilot drill hole 526 arranged between the first end 502 and the second end 504 on the central axis 516 of the template. In this embodiment, the second pilot drill hole 526 is configured to permit forming an electrical conduit drill hole, knockout, or knockout hole 528 having a diameter of about 1½ inch. The second pilot hole 526 extends through the entire thickness of the template 500.

The knockout 528 is formed using a pilot hole 526 and a hole saw, or hole cutter as known in the art. On bigger conduit sizes the pilot hole 526 is used with a hole saw followed by using a knockout tool as known in the art. In any of the conduit sizes the pilot hole 528 is utilized to prevent any measuring and rapid.

In this embodiment, the line 530 is parallel to the second end 504 and tangential to an outside diameter of the knockout 528. The line 530 is configured to mimic or represent the outside portion or depth of a 13/16 inch (or ⅞ inch) mounting strut, channel strut, e.g., Unistrut®. The 13/16 inch (or ⅞ inch) strut (not shown) is mounted to a wall, ceiling, floor, or substrate and configured to allow securing and support of conduits with straps (not shown) to the strut.

Optionally and/or alternatively, the template 500 also includes graphic region 532 to include a size of the conduit the template can be used with, e.g., 1½ inch EMT conduit. The center line 516 can be solid or dashed. Optionally and/or alternatively, the template 500 has a substantially rectangular shape with cut corner, beveled corners and corners having a right angle. In this embodiment, the template includes a plastic semi-rigid material with a magnetic material adhered to reverse side. The magnetic material is configured to allow the template to be releasably attached to a panel. Optionally and/or alternatively, the template 500 can include a graphic (see FIG. 2) that resembles an attachment strap used to attach the conduit to the strut.

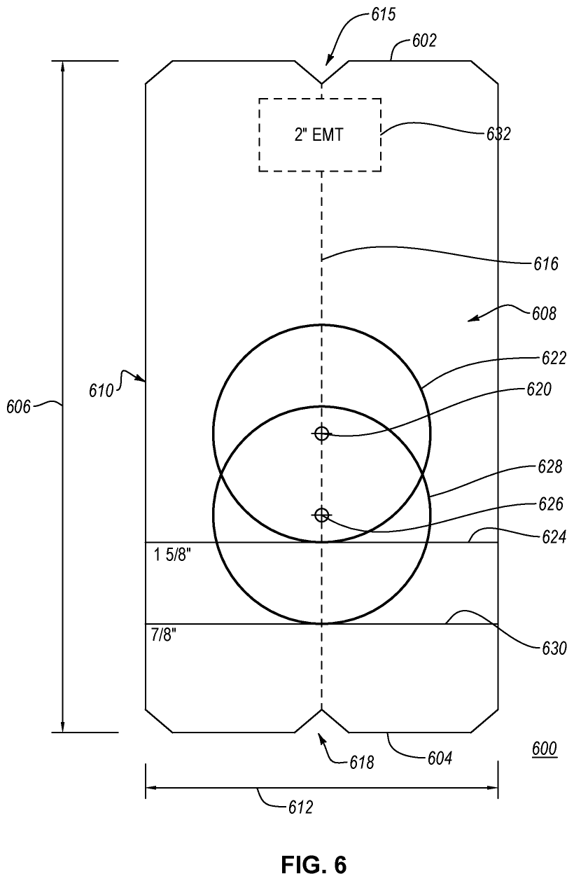

FIG. 6 illustrates an exemplary view of a 2 inch conduit layout apparatus for use with a 1⅝ inch and 13/16 inch (or ⅞ inch) strut channel according to an embodiment of the invention.

Referring to FIG. 6, the template is 2 inch conduit layout apparatus for use with a 1⅝ inch and 13/16 inch (or ⅞ inch) strut channel. The 2 inch conduit apparatus is generally depicted with reference number 600. The template 600 is configured for a 2 inch conduit, e.g., electric metallic tube (EMT) conduit, rigid conduit, and other electrical conducts described herein and the like. The template 600 includes a first end 602, a second end 604 spaced apart from the first end by a length 606, a first side 608 and a second side 610 spaced apart from the first side 608 by a width 612, wherein the width 612 is less than the length 606.

The first end 602 includes a first end notch 615 arranged between the first side 608 and the second side 610 configured to indicate a central axis or midline 616 of the template 600. The second end 604 includes a second end notch 618 arranged between the first side 608 and the second side 610 configured to indicate the central axis or midline 616 of the template 600.

The template 600 includes a first pilot drill hole 620 arranged between the first end 602 and the second end 604 on the central axis 616 of the template. In this embodiment, the first pilot drill hole 620 is configured to permit forming an electrical conduit drill hole, knock-out, or knockout hole 622 having a diameter of about 2 inch.

The knockout 622 is formed using a pilot hole 620 and a hole saw as known in the art. On bigger conduit sizes the pilot hole 620 is used with a hole saw followed by using a knockout tool as known in the art. In any of the conduit sizes the pilot hole 620 is utilized to prevent any measuring and allow rapid for rapid use and throughput. The pilot hole 620 extends through the entire thickness of the template 600.

In this embodiment, the line 624 is parallel to the second end 604 and tangential to an outside diameter of the knockout 622. The line 624 is configured to mimic or represent the outside portion or depth of a mounting strut, channel strut, e.g., Unistrut®. The strut (not shown) is mounted to a wall, ceiling, floor, or substrate and configured to allow securing and support of conduits with straps (not shown) to the strut. Typically, strut sizes vary in widths of the strut are 1⅝ inches, or 13/16 inches (or ⅞ inch strut). In this embodiment, the line 624 is configured to represent a 1⅝ inch strut.

The template 600 also includes a second pilot drill hole 626 arranged between the first end 602 and the second end 604 on the central axis 616 of the template. In this embodiment, the second pilot drill hole 626 is configured to permit forming an electrical conduit drill hole, knockout, or knockout hole 628 having a diameter of about 2 inch. The second pilot hole 626 extends through the entire thickness of the template 600.

The knockout 628 is formed using a pilot hole 626 and a hole saw, or hole cutter as known in the art. On bigger conduit sizes the pilot hole 626 is used with a hole saw followed by using a knockout tool as known in the art. In any of the conduit sizes the pilot hole 528 is utilized to prevent any measuring and rapid.

In this embodiment, the line 630 is parallel to the second end 604 and tangential to an outside diameter of the knockout 628. The line 630 is configured to mimic or represent the outside portion or depth of a 13/16 inch (or ⅞ inch) mounting strut, channel strut, e.g., Unistrut®. The 1⅝ inch and 13/16 inch (or ⅞ inch) strut (not shown) is mounted to a wall, ceiling, floor, or substrate and configured to allow securing and support of conduits with straps (not shown) to the strut. Optionally and/or alternatively, the template 600 also includes graphic region 632 to include a size of the conduit the template can be used with, e.g., 2 inch EMT conduit. The center line 616 can be solid or dashed. Optionally and/or alternatively, the template 600 has a substantially rectangular shape with cut corner, beveled corners and corners having a right angle. In this embodiment, the template includes a plastic semi-rigid material with a magnetic material adhered to reverse side. The magnetic material is configured to allow the template to be releasably attached to a panel. Optionally and/or alternatively, the template 500 can include a graphic (see FIG. 2) that resembles an attachment strap used to attach the conduit to the strut.

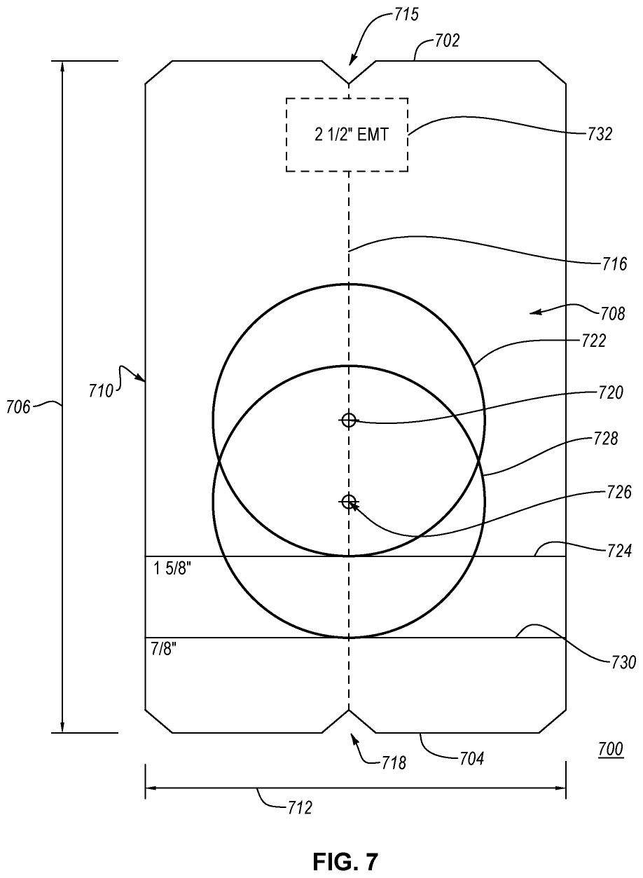

FIG. 7 illustrates an exemplary view of a 2½ inch conduit layout apparatus for use with a 1⅝ inch and 13/16 inch (or ⅞ inch) strut channel according to an embodiment of the invention.

Referring to FIG. 7, the template is 2½ inch conduit layout apparatus for use with a 1⅝ inch and 13/16 inch (or ⅞ inch) strut channel. The 2½ inch conduit apparatus is generally depicted with reference number 700. The template 700 is configured for a 2 inch conduit, e.g., electric metallic tube (EMT) conduit, rigid conduit, and other electrical conducts described herein and the like. The template 700 includes a first end 702, a second end 704 spaced apart from the first end by a length 706, a first side 708 and a second side 710 spaced apart from the first side 708 by a width 712, wherein the width 712 is less than the length 706.

The first end 702 includes a first end notch 715 arranged between the first side 708 and the second side 710 configured to indicate a central axis or midline 716 of the template 700. The second end 704 includes a second end notch 718 arranged between the first side 708 and the second side 710 configured to indicate the central axis or midline 716 of the template 700.

The template 700 includes a first pilot drill hole 720 arranged between the first end 702 and the second end 704 on the central axis 716 of the template. In this embodiment, the first pilot drill hole 720 is configured to permit forming an electrical conduit drill hole, knock-out, or knockout hole 722 having a diameter of about 2½ inch.

The knockout 722 is formed using a pilot hole 720 and a hole saw as known in the art. On bigger conduit sizes the pilot hole 720 is used with a hole saw followed by using a knockout tool as known in the art. In any of the conduit sizes the pilot hole 720 is utilized to prevent any measuring and allow rapid for rapid use and throughput. The pilot hole 720 extends through the entire thickness of the template 700.

In this embodiment, the line 724 is parallel to the second end 604 and tangential to an outside diameter of the knockout 722. The line 724 is configured to mimic or represent the outside portion or depth of a mounting strut, channel strut, e.g., Unistrut®. The strut (not shown) is mounted to a wall, ceiling, floor, or substrate and configured to allow securing and support of conduits with straps (not shown) to the strut. Typically, strut sizes vary in widths of the strut are 1⅝ inches, or 13/16 inches (or ⅞ inch strut). In this embodiment, the line 724 is configured to represent a 1⅝ inch strut.

The template 700 also includes a second pilot drill hole 726 arranged between the first end 702 and the second end 704 on the central axis 716 of the template. In this embodiment, the second pilot drill hole 726 is configured to permit forming an electrical conduit drill hole, knockout, or knockout hole 728 having a diameter of about 2½ inch. The second pilot hole 726 extends through the entire thickness of the template 700.

The knockout 728 is formed using a pilot hole 726 and a hole saw, or hole cutter as known in the art. On bigger conduit sizes the pilot hole 726 is used with a hole saw followed by using a knockout tool as known in the art. In any of the conduit sizes the pilot hole 728 is utilized to prevent any measuring and rapid.

In this embodiment, the line 730 is parallel to the second end 604 and tangential to an outside diameter of the knockout 728. The line 730 is configured to mimic or represent the outside portion or depth of a 13/16 inch (or ⅞ inch) mounting strut, channel strut, e.g., Unistrut®. The 1⅝ inch and 13/16 inch (or ⅞ inch) strut (not shown) is mounted to a wall, ceiling, floor, or substrate and configured to allow securing and support of conduits with straps (not shown) to the strut. Optionally and/or alternatively, the template 600 also includes graphic region 732 to include a size of the conduit the template can be used with, e.g., 2½ inch EMT conduit. The center line 716 can be solid or dashed. Optionally and/or alternatively, the template 700 has a substantially rectangular shape with cut corner, beveled corners and corners having a right angle. In this embodiment, the template includes a plastic semi-rigid material with a magnetic material adhered to reverse side. The magnetic material is configured to allow the template to be releasably attached to a panel. Optionally and/or alternatively, the template 700 can include a graphic (see FIG. 2) that resembles an attachment strap used to attach the conduit to the strut.

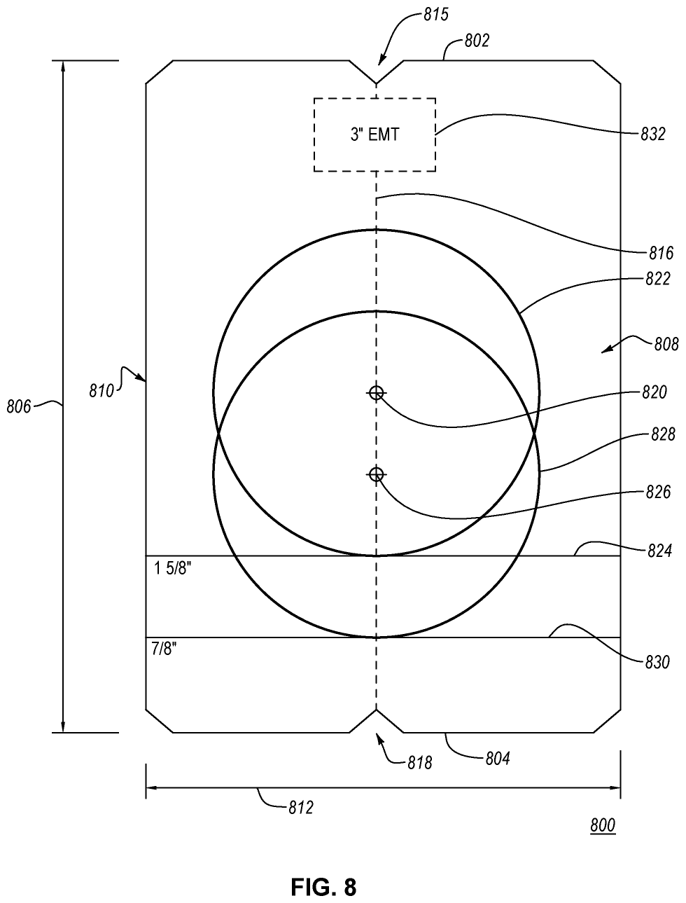

FIG. 8 illustrates an exemplary view of a 3 inch conduit layout apparatus for use with a 1⅝ inch and 13/16 inch (or ⅞ inch) strut channel according to an embodiment of the invention.

Referring to FIG. 8, the template is 3 inch conduit layout apparatus for use with a 1⅝ inch and 13/16 inch (or ⅞ inch) strut channel. Referring to FIG. 8, the template is 3 inch conduit layout apparatus for use with a 1⅝ inch and 13/16 inch (or ⅞ inch) strut channel. The 3 inch conduit apparatus is generally depicted with reference number 800. The template 800 is configured for a 3 inch conduit, e.g., electric metallic tube (EMT) conduit, rigid conduit, and other electrical conducts described herein and the like. The template 800 includes a first end 802, a second end 804 spaced apart from the first end by a length 806, a first side 808 and a second side 810 spaced apart from the first side 808 by a width 812, wherein the width 812 is less than the length 806.

The first end 802 includes a first end notch 815 arranged between the first side 808 and the second side 810 configured to indicate a central axis or midline 816 of the template 800. The second end 804 includes a second end notch 818 arranged between the first side 708 and the second side 710 configured to indicate the central axis or midline 716 of the template 800.

The template 800 includes a first pilot drill hole 820 arranged between the first end 802 and the second end 804 on the central axis 816 of the template. In this embodiment, the first pilot drill hole 820 is configured to permit forming an electrical conduit drill hole, knock-out, or knockout hole 822 having a diameter of about 3 inch.

The knockout 822 is formed using a pilot hole 820 and a hole saw as known in the art. On bigger conduit sizes the pilot hole 820 is used with a hole saw followed by using a knockout tool as known in the art. In any of the conduit sizes the pilot hole 820 is utilized to prevent any measuring and allow rapid for rapid use and throughput. The pilot hole 820 extends through the entire thickness of the template 800.

In this embodiment, the line 824 is parallel to the second end 804 and tangential to an outside diameter of the knockout 822. The line 824 is configured to mimic or represent the outside portion or depth of a mounting strut, channel strut, e.g., Unistrut®. The strut (not shown) is mounted to a wall, ceiling, floor, or substrate and configured to allow securing and support of conduits with straps (not shown) to the strut. Typically, strut sizes vary in widths of the strut are 1⅝ inches, or 13/16 inches (or ⅞ inch strut). In this embodiment, the line 824 is configured to represent a 1⅝ inch strut.

The template 800 also includes a second pilot drill hole 826 arranged between the first end 802 and the second end 804 on the central axis 816 of the template. In this embodiment, the second pilot drill hole 826 is configured to permit forming an electrical conduit drill hole, knockout, or knockout hole 828 having a diameter of about 3 inch. The second pilot hole 826 extends through the entire thickness of the template 800.

The knockout 828 is formed using a pilot hole 826 and a hole saw, or hole cutter as known in the art. On bigger conduit sizes the pilot hole 826 is used with a hole saw followed by using a knockout tool as known in the art. In any of the conduit sizes the pilot hole 828 is utilized to prevent any measuring and rapid.

In this embodiment, the line 830 is parallel to the second end 604 and tangential to an outside diameter of the knockout 828. The line 830 is configured to mimic or represent the outside portion or depth of a 13/16 inch (or ⅞ inch) mounting strut, channel strut, e.g., Unistrut®. The 1⅝ inch and 13/16 inch (or ⅞ inch) strut (not shown) is mounted to a wall, ceiling, floor, or substrate and configured to allow securing and support of conduits with straps (not shown) to the strut. Optionally and/or alternatively, the template 600 also includes graphic region 832 to include a size of the conduit the template can be used with, e.g., 3 inch EMT conduit. The center line 816 can be solid or dashed. Optionally and/or alternatively, the template 800 has a substantially rectangular shape with cut corner, beveled corners and corners having a right angle. In this embodiment, the template includes a plastic semi-rigid material with a magnetic material adhered to reverse side. The magnetic material is configured to allow the template to be releasably attached to a panel. Optionally and/or alternatively, the template 800 can include a graphic (see FIG. 2) that resembles an attachment strap used to attach the conduit to the strut.

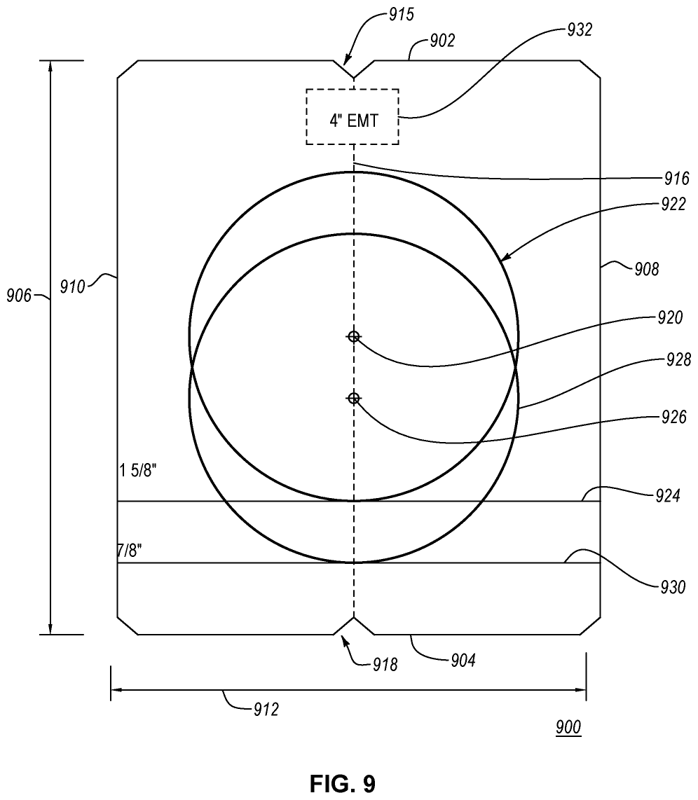

FIG. 9 illustrates an exemplary view of a 4 inch conduit layout apparatus for use with a 1⅝ inch and 13/16 inch (or ⅞ inch) strut channel according to an embodiment of the invention.

Referring to FIG. 9, the template is 4 inch conduit layout apparatus for use with a 1⅝ inch and 13/16 inch (or ⅞ inch) strut channel. The 4 inch conduit apparatus is generally depicted with reference number 900. The template 900 is configured for a 4 inch conduit, e.g., electric metallic tube (EMT) conduit, rigid conduit, and other electrical conducts described herein and the like. The template 900 includes a first end 902, a second end 904 spaced apart from the first end by a length 906, a first side 908 and a second side 910 spaced apart from the first side 908 by a width 912, wherein the width 912 is less than the length 906.

The first end 902 includes a first end notch 915 arranged between the first side 908 and the second side 910 configured to indicate a central axis or midline 916 of the template 900. The second end 904 includes a second end notch 918 arranged between the first side 908 and the second side 910 configured to indicate the central axis or midline 916 of the template 900.

The template 900 includes a first pilot drill hole 920 arranged between the first end 902 and the second end 904 on the central axis 916 of the template. In this embodiment, the first pilot drill hole 920 is configured to permit forming an electrical conduit drill hole, knock-out, or knockout hole 922 having a diameter of about 4 inch.

The knockout 922 is formed using a pilot hole 920 and a hole saw as known in the art. On bigger conduit sizes the pilot hole 920 is used with a hole saw followed by using a knockout tool as known in the art. In any of the conduit sizes the pilot hole 920 is utilized to prevent any measuring and allow rapid for rapid use and throughput. The pilot hole 820 extends through the entire thickness of the template 900.

In this embodiment, the line 924 is parallel to the second end 804 and tangential to an outside diameter of the knockout 922. The line 924 is configured to mimic or represent the outside portion or depth of a mounting strut, channel strut, e.g., Unistrut®. The strut (not shown) is mounted to a wall, ceiling, floor, or substrate and configured to allow securing and support of conduits with straps (not shown) to the strut. Typically, strut sizes vary in widths of the strut are 1⅝ inches, or 13/16 inches (or ⅞ inch strut). In this embodiment, the line 924 is configured to represent a 1⅝ inch strut.

The template 900 also includes a second pilot drill hole 926 arranged between the first end 902 and the second end 904 on the central axis 916 of the template. In this embodiment, the second pilot drill hole 926 is configured to permit forming an electrical conduit drill hole, knockout, or knockout hole 928 having a diameter of about 4 inch. The second pilot hole 926 extends through the entire thickness of the template 900.

The knockout 928 is formed using a pilot hole 926 and a hole saw, or hole cutter as known in the art. On bigger conduit sizes the pilot hole 926 is used with a hole saw followed by using a knockout tool as known in the art. In any of the conduit sizes the pilot hole 928 is utilized to prevent any measuring and rapid.

In this embodiment, the line 930 is parallel to the second end 904 and tangential to an outside diameter of the knockout 928. The line 930 is configured to mimic or represent the outside portion or depth of a 13/16 inch (or ⅞ inch) mounting strut, channel strut, e.g., Unistrut®. The 1⅝ inch and 13/16 inch (or ⅞ inch) strut (not shown) is mounted to a wall, ceiling, floor, or substrate and configured to allow securing and support of conduits with straps (not shown) to the strut. Optionally and/or alternatively, the template 600 also includes graphic region 932 to include a size of the conduit the template can be used with, e.g., 4 inch EMT conduit. The center line 916 can be solid or dashed. Optionally and/or alternatively, the template 900 has a substantially rectangular shape with cut corner, beveled corners and corners having a right angle. In this embodiment, the template includes a plastic semi-rigid material with a magnetic material adhered to reverse side. The magnetic material is configured to allow the template to be releasably attached to a panel. Optionally and/or alternatively, the template 900 can include a graphic (see FIG. 2) that resembles an attachment strap used to attach the conduit to the strut.

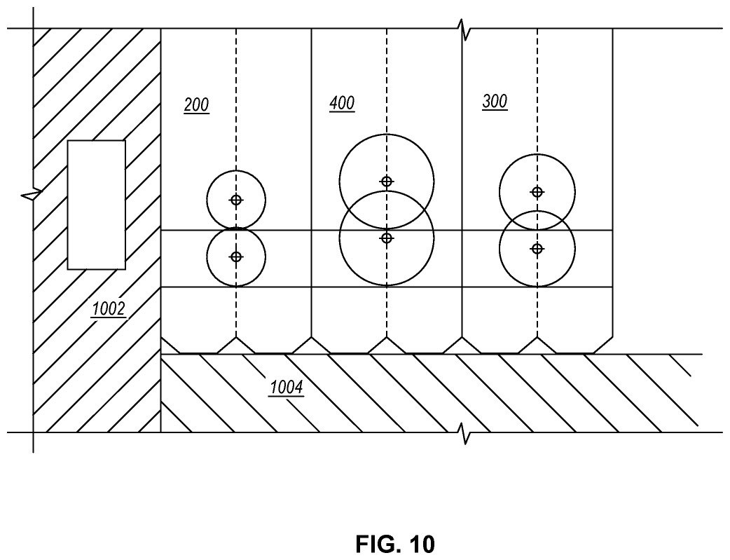

FIG. 10 illustrates an exemplary view of a ¾ inch conduit layout apparatus, 1¼ inch conduit layout apparatus and 1 inch conduit layout apparatus arranged side by side on a panel for use with a 1⅝ inch and 13/16 inch (or ⅞ inch) strut channel according to an embodiment of the invention.

Referring to FIG. 10, various different size templates are used side by side to form different size knockouts. More specifically, the template 200, template 400 and template 300 are arranged on panel 1002 and positioned such the second end of each template is directly adjacent to the wall 1004. The pilot holes are marked and the knockouts are formed rapidly with 2 inch spacing center to center of each knockout.

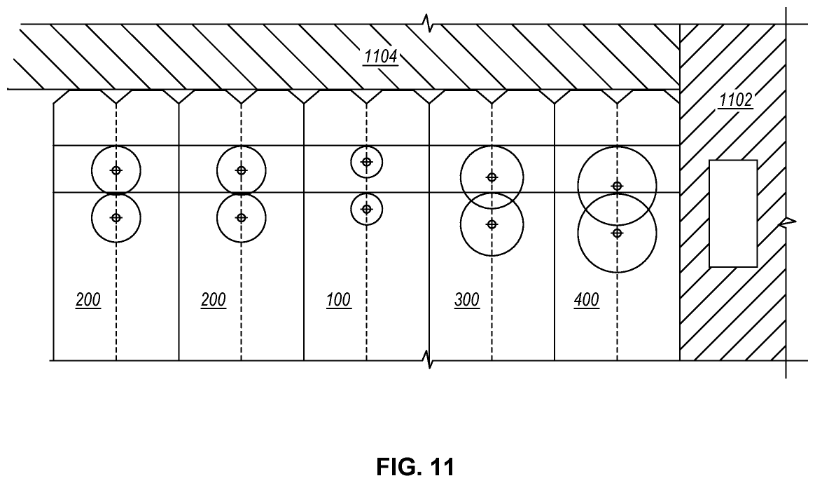

FIG. 11 illustrates an exemplary view of a ¾ inch conduit layout apparatus, ¾ inch conduit layout apparatus, ½ inch conduit layout apparatus and 1¼ inch conduit layout apparatus arranged side by side on a panel for use with a 1⅝ inch and 13/16 inch (or ⅞ inch) strut channel according to an embodiment of the invention.

Referring to FIG. 11, various different size templates are used side by side to form different size knockouts. More specifically, the template 200, template 200, template 100, template 300 and template 400 are arranged on panel 1102 and positioned such the second end of each template is directly adjacent to the wall 1104. The pilot holes are marked, and the knockouts are formed rapidly with 2 inch spacing center to cent of each knockout.

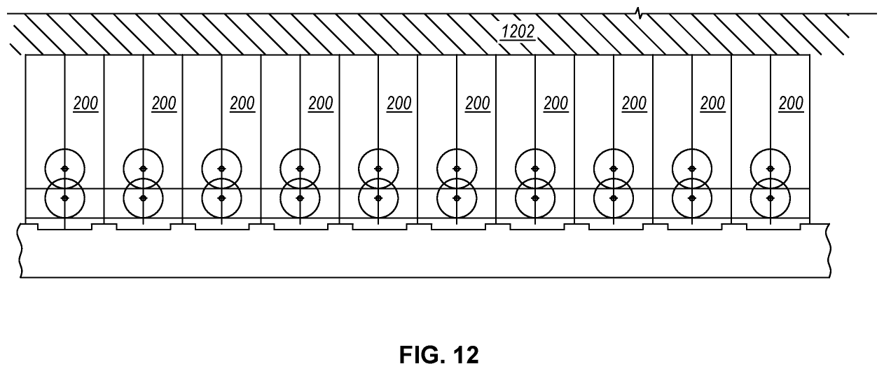

FIG. 12 illustrates an exemplary view of ten ¾ inch conduit layout apparatuses arranged side by side on a panel for use with a 1⅝ inch strut channel according to an embodiment of the invention.

Referring to FIG. 12, the same sized templates are used side by side to form knockouts rapidly with 2 inch spacing center to center of each knockout. More specifically, ten template 200 are positioned such the second end of each template is directly adjacent to the wall 1104. The pilot holes are marked, and the knockouts are formed rapidly with 2 inch spacing center to cent of each knockout. It also shows a 1⅝ strut, so the first pilot hole 220 of each template 200 is used.

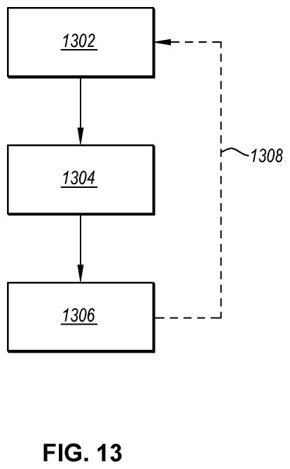

FIG. 13 illustrates an exemplary flowchart view of method of using the conduit layout apparatus.

Referring to FIG. 13, the process is used with different sized templates as described herein. In this embodiment, the electrician decides which size strut will be used and the number and size of each knockout for the conduit in the box (step 1302). Next, the user obtains the various templates (step 1304). The user then arranging the templates on the with the desired spacing. The user then marks the drill hole and uses the drill hole to form the knockout as described herein (step 1306) and repeat as necessary 1308.

The inventions and methods described herein can be viewed as a whole, or as a number of separate inventions, that can be used independently or mixed and matched as desired. All inventions, steps, processed, devices, and methods described herein can be mixed and matched as desired. All previously described features, functions, or inventions described herein or by reference may be mixed and matched as desired.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A template for arranging electrical conduit drill hole positions on an electrical panel housing, the apparatus comprising:
a first end, a second end spaced apart from the first end by a length, a first side and a second side spaced apart from the first side by a width, wherein the width is less than the length,
wherein the first end comprises a first end notch arranged between the first side and the second side configured to indicate a central axis or midline of the template,
wherein the second end comprises a second end notch arranged between the first side and the second side configured to indicate the central axis or midline of the template,
a first pilot drill hole configured to be used to form an electrical conduit drill hole and arranged between the first end and the second end on the central axis of the template, wherein the first pilot hole is arranged at a location for use with a 1⅝ inch strut channel; and
a second pilot drill hole configured to be used to form an electrical conduit drill hole arranged between the first end and the second end on the central axis of the template, wherein the first pilot hole is arranged at a location for use with a 13/16 or ⅞ inch strut channel.

2. The template of claim 1, wherein the template further comprises a magnetic material.

3. The template of claim 1, wherein template further comprises a magnetic material adhered to at least a portion of the template.

4. The template of claim 1, wherein the template is a sticker or decal.

5. The template of claim 1, wherein the template comprises a material selected from the group consisting of a metal material, an aluminum material, an alloy material, a thermoplastic material, a plastic material, a paper material, a cardboard material, a magnetic material and combinations of the same.

6. The template of claim 1, wherein the width is about 2 inches.

7. The template of claim 1, wherein the electrical conduit drill hole is sized in a range from ¼ inch to 4 inch or greater.

8. The template of claim 1, wherein the electrical conduit drill hole is configured for a ½ inch electrical conduit.

9. The template of claim 1, wherein the electrical conduit drill hole is configured for a ¾ inch electrical conduit.

10. The template of claim 1, wherein the electrical conduit drill hole is configured for a 1 inch electrical conduit.

11. The template of claim 1, wherein the electrical conduit drill hole is configured for a 1¼ inch electrical conduit.

12. The template of claim 1, wherein the electrical conduit drill hole is configured for a 1½ inch electrical conduit.

13. The template of claim 1, wherein the electrical conduit drill hole is configured for a 2 inch electrical conduit.

14. The template of claim 1, wherein the electrical conduit drill hole is configured for a 2½ inch electrical conduit.

15. The template of claim 1, wherein the electrical conduit drill hole is configured for a 3 inch electrical conduit.

16. The template of claim 1, wherein the electrical conduit drill hole is configured for a 3½ inch electrical conduit.

17. The template of claim 1, wherein the electrical conduit drill hole is configured for a 4 inch electrical conduit.

18. The template according to claims 1-16, wherein the electrical conduit is an EMT electrical conduct.

19. The template of claim 1, wherein the template is configured to allow for NECA spacing.

20. A method for laying out the locations of electrical conduit entry holes to be made on an electrical panel housing comprising:
(a) providing a template comprising: a first end, a second end spaced apart from the first end by a length, a first side and a second side spaced apart from the first side by a width, wherein the width is less than the length, wherein the first end comprises a first end notch arranged between the first side and the second side configured to indicate a central axis or midline of the template, wherein the second end comprises a second end notch arranged between the first side and the second side configured to indicate the central axis or midline of the template, a first pilot drill hole configured to be used to form an electrical conduit drill hole and arranged between the first end and the second end on the central axis of the template, wherein the first pilot hole is arranged at a location for use with a 1⅝ inch strut channel; and a second pilot drill hole configured to be used to form an electrical conduit drill hole and arranged between the first end and the second end on the central axis of the template, wherein the first pilot hole is arranged at a location for use with a 13/16 or ⅞ inch strut channel;
(b) arranging the template on the electrical panel in a preconfigured orientation;
(c) marking the electrical panel with one of the first pilot drill hole or second pilot drill hole; and
(d) forming a knockout with the first pilot drill hole or the second pilot drill hole.

21. The method of claim 20, repeating steps (a)-(d).

22. The method of claim 20, wherein the electrical conduit drill hole is sized in a range from ¼ inch to 4 inch or greater.
